(19) United States
(12) Patent Application Publication
(10) Pub. No.: US 2023/0145139 A1
(43) Pub. Date: May 11, 2023

(54) MICROWAVE COOKING DEVICE

(71) Applicant: TWO PILLARS, LLC, Irvine, CA (US)

(72) Inventor: Vsevolod MOULER, Irvine, CA (US)

(73) Assignee: TWO PILLARS, LLC, Irvine, CA (US)

(21) Appl. No.: 17/521,702

(22) Filed: Nov. 8, 2021

(51) Int. Cl. H05B 6/64; F24C 15/16; A47J 36/02; A47J 45/08; A47J 27/04

(52) U.S. Cl. CPC H05B 6/6497; F24C 15/16; A47J 36/027; A47J 45/08; A47J 27/04; A47J 2027/043

(57) ABSTRACT

A microwave cooking device is used for cooking food using steam inside a microwave oven. The device includes an outer body with a top portion that has a recessed portion with the ability to hold water, to aid in the microwave cooking and reheating process, protruding inwardly and towards a bottom portion of the device. The device further includes ridges on the outer body configured to be collapsible and expandable. The device has handles on the outer body configured to allow a user to pick up the device or hot dishware after microwaving. The recessed portion of the device includes (i) a rotatable knob with plurality of leaves, and (ii) plurality of holes. The device prevents splattering of food inside the microwave oven and is inexpensive, eco-friendly, easy to use and can be washed in the dishware after use.

### FIELD OF THE INVENTION

The present invention relates to a device which helps in uniquely cooking new dishes in a microwave oven using steam and also helps in maintaining moisture of foods being reheated. The present invention also generally relates to a re-usable device for the microwave oven and more particularly to a device which prevents food, that is being cooked or re-heated inside the microwave oven, from splattering or splashing out.

### BACKGROUND OF THE INVENTION

With the development of microwave ovens, there has been a coincidental development of devices and accessories that are adaptable for use within the microwave ovens because of the unique qualities of the devices and accessories of the microwave system. The various devices and accessories presently available in the market mostly relate to preventing food items from splattering and soiling inside the microwave oven. The known devices or accessories are only able to prevent splattering of food inside the oven but are unable to help in maintaining moisture and temperature of the food, during cooking or re-heating of the food inside the microwave oven. Moreover, no device or accessory exists which provides a solution to uniquely cook new dishes in the microwave oven using steam.

The construction of the known devices is such that they are unable to maintain or hold the moisture of the food when food is cooked or re-heated inside a microwave and are only equipped to prevent splattering of the food items inside the microwave oven. Moreover, once the food is cooked or re-heated and kept outside the microwave oven, no device or accessory presently known in the market helps in maintaining the moisture of the food, thereby leading to a situation where the cooked or re-heated food may eventually lose all the moisture rendering it uneatable.

In order to overcome the aforesaid problems, the inventors after significant research and development have arrived at a novel and inventive device for uniquely cooking food inside a microwave oven using steam. The device is further configured to protect food from splattering or splashing inside a microwave oven. The novel and inventive cooking device configured and provided herewith substantially departs from the conventional concepts and technology available in the market or existing in the prior arts. The device is configured to create an airtight hermetic seal around the food being cooked or re-heated which increases steam temperature and steam flow, while decreasing the normal time to cook or re-heat the food. The device is configured to simultaneously retain the moisture of the food due to the airtight hermetic seal which is created by the device around the food, thereby not allowing water molecules to escape from the cooked or re-heated food. The device is particularly configured to maintain moisture and temperature of the food, during cooking or re-heating of the food inside the microwave oven, for a longer duration. The device further helps in maintaining moisture and temperature of the food outside the microwave oven for a longer duration after cooking or re-heating of the food is completed. Further, the device is collapsible in nature and is relatively inexpensive, eco-friendly, easy to use and can be washed immediately after use.

### SUMMARY AND OBJECTIVES OF THE INVENTION

The following presents a simplified summary of the subject matter in order to provide a basic understanding of some aspects of the embodiments of the present invention. This summary is not an extensive overview of the subject matter. It is not intended to identify key/critical elements of the embodiments or to delineate the scope of the subject matter.

The primary objective of the present invention is to provide a novel and inventive device which helps in uniquely cooking new dishes in a microwave oven using steam. Additionally, the present invention is a novel and inventive device that prevents food (including liquid food), that is being cooked or re-heated, inside a microwave oven from splattering or splashing out. The device further helps in maintaining moisture and temperature of the food, during cooking or re-heating of the food inside the microwave oven, for a longer duration. The device further helps in maintaining moisture and temperature of the food outside the microwave oven for a longer duration after cooking or re-heating of the food is completed.

Another objective of the present invention is to provide a device of unique construction which is collapsible in nature, compact, inexpensive, eco-friendly, easy to use and can be cleaned immediately subsequent to use, if desired.

Yet another objective of the present invention is to provide a collapsible and a compact device comprising magnets embedded or integrated at a top portion of the device. The device is configured to be easily attachable to the interior walls, especially top interior wall, of the microwave oven and may be kept compactly and safely inside the microwave oven itself once the use of the device is completed. Unlike other devices or accessories known in the art, the present device is not necessarily required to be taken out of the microwave oven since it can be easily and compactly kept inside the microwave oven after use or when not in use. The devices or accessories already available in the market have to be necessarily taken out in order to put a dishware containing food inside the microwave for cooking or re-heating purposes—which is a big hassle for a user.

Yet another objective of the present invention is to provide a device wherein the top portion of the device comprises a recess portion for receiving and holding water until a fill line, and which may be used for keeping the food moist while the food is cooked or re-heated inside the microwave oven. The recess portion of the device further comprises a rotatable knob with plurality of leaves, and plurality of holes configured to allow the water present at the recess portion to trickle downwards while the food is being cooked or re-heated inside the microwave oven, thereby keeping the food moist and fresh for a longer duration.

Yet another objective of the present invention is to provide a device which is configured to fully cover a dishware containing the food inside the microwave oven and is further configured to create an airtight hermetic seal with a turntable tray of the microwave oven while the food is cooked or re-heated inside the microwave oven. The device is also configured to create the airtight hermetic seal with any surface (including the dishware containing the food) when the plurality of holes at the top portion are closed by the plurality of leaves, thereby keeping the cooked or re-heated food hot for a longer duration and also maintaining the moisture and temperature of the cooked or re-heated food for longer duration.

Yet another objective of the present invention is to provide a device which not only protects the food from splattering and/or splashing out from the microwave oven but also maintains the moisture and temperature content of the food inside as well as outside the microwave oven.

Further objective of the present invention is to provide a device which has handles at sides made up of silicone material. The device is configured in a manner that the handles of the device do not get over heated when the device is in operation inside the microwave oven. The handles of the device also protect the hands of the user from burning or getting hurt in any manner while picking the cooked or re-heated food from the microwave oven.

Another objective of the present invention is to provide a device to cook or re-heat the food more uniformly and evenly, leaving no hot or cold spots in the food after cooking or re-heating.

The invention now will be described more fully hereinafter with reference to the accompanying drawings, which are intended to be read in conjunction with both this summary and objective of the invention, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

The present invention may be better understood, and its numerous objects, features, components and advantages are made apparent to those skilled in the art, by referring to the accompanying drawing, in which:

FIG. 1 illustrates a front top perspective view of the cooking device for a microwave oven.

FIGS. 2 and 3 illustrate front and rear views of another embodiment of the cooking device for microwave oven.

FIG. 4 illustrates a top view of the cooking device for microwave oven.

FIG. 5 illustrates another top view of the cooking device for microwave oven.

FIG. 6 illustrates a bottom inner view of the cooking device for microwave oven.

FIG. 7 and FIG. 8 illustrate left-side and right-side views of the cooking device for microwave oven.

FIG. 9 illustrates a perspective view of the cooking device for microwave oven in use in a microwave oven.

### DETAILED DESCRIPTION OF THE INVENTION

The following description describes various features and functions of the disclosed device with reference to the accompanying figures. The terminology used herein is for the purpose of describing particular embodiments only and is not intended to limit the scope of the present invention.

The detailed description is construed as a description of the currently preferred embodiments of the present invention and does not represent the only form in which the present invention may be practiced. This is to be understood that the same or equivalent functions may be accomplished, in any order unless expressly and necessarily limited to a particular order, by different embodiments that are intended to be encompassed within the scope of the present invention.

The embodiment is chosen and described to provide the best illustration of the principles of the invention and its practical application and to enable one of ordinary skill in the art to utilize the invention in various embodiments and with various modifications as are suited to the particular use contemplated.

Furthermore, there is no intention to be bound by any expressed or implied theory presented in the preceding technical field, background, brief summary or the following detailed description. It is further understood that the relational terms such as first, second etc., if any, are used solely to distinguish one from another entity, item or action without necessarily requiring or implying any actual such relationship or order between such entities, items or actions.

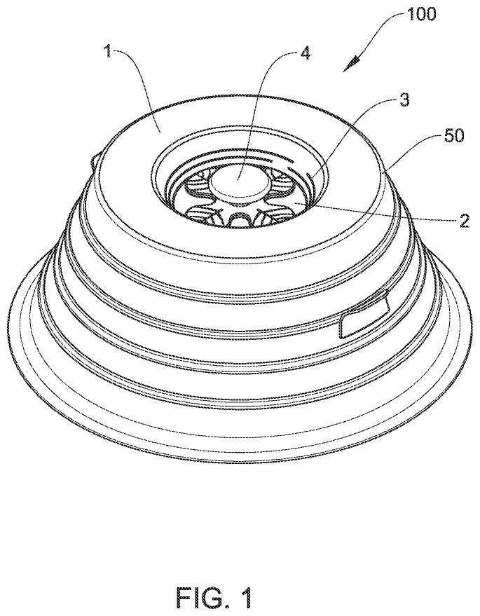

Referring now to the Figures, FIG. 1 represents a front top perspective view of the device for use inside or outside a microwave oven (200). The device (100) is configured to uniquely cook food inside the microwave oven (200) using steam and also to prevent food, that is being cooked or re-heated inside a microwave oven, from splattering or splashing out. The device (100) further helps in maintaining moisture and temperature of the food, during cooking or re-heating of the food inside the microwave oven (200), for a longer duration. The device (100) further helps in maintaining moisture and temperature of the food outside the microwave oven (200) for a longer duration after cooking or re-heating of the food is completed. In an embodiment, the device (100) comprises a frustum-shaped outer body (50) with a top portion (1) wherein the top portion (1) comprises a recess portion (2) which is protruding inwardly towards a bottom portion of the device (100). It can be easily understood that the outer body of the device (100) may have different shapes and the frustum-shaped structure described in the specification is only for explanation purposes. The recess portion (2) of the device (100) is configured for receiving and holding water which may be used for keeping the food moist when the food is cooked or re-heated inside the microwave oven (200). The water in the recess portion (2) can be received and collected until a fill line (3)—which fill line (3) is shown in FIG. 1.

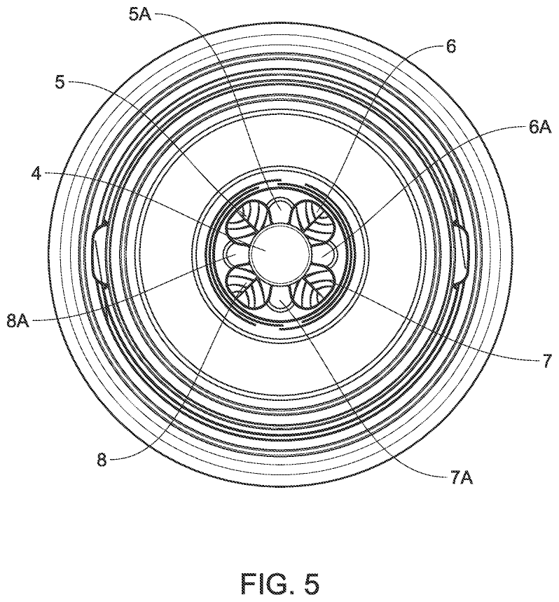

In an embodiment, the recess portion (2) further comprises a rotatable knob (4) with plurality of leaves (5, 6, 7, 8), and plurality of holes (5A, 6A, 7A, 8A) (shown in FIG. 5). It can be easily understood that the plurality of leaves and the plurality of holes can be present in any number in the device and the number of leaves and holes used and described in the present embodiment in the specification is only for explanation purposes. The plurality of holes (5A, 6A, 7A, 8A) allow water collected until the fill line (3) at the recess portion (2) to flow downwards during the cooking or re-heating process, thereby keeping the food moist and fresh. In an embodiment, the knob (4) is also helpful in easily lifting the device (100) once the cooking or re-heating is completed.

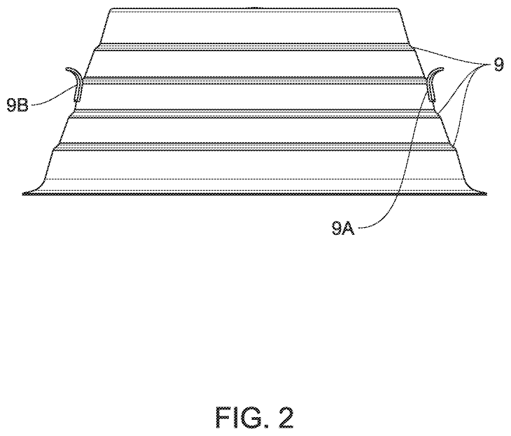

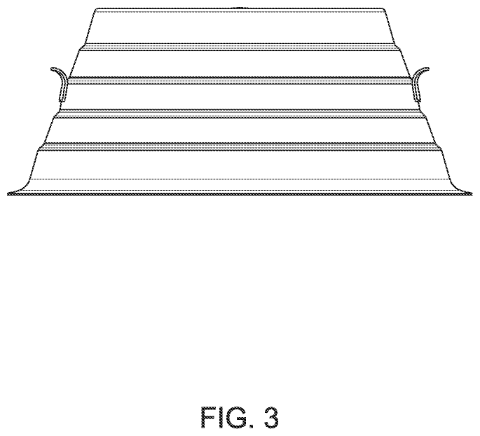

Referring now to FIGS. 2 and 3 which represent the front and back views of the cooking device for microwave oven (100). In an embodiment, the device (100) comprises a plurality of circular ridges (9) at the outer part of the device (100) as shown in the FIGS. 2 and 3. The circular ridges (9) are collapsible and foldable in nature thereby allowing the device (100) to be compactly kept inside or outside the microwave oven (200) after use. The circular ridges (9) radially expand and open together when the device (100) is in unfolded stage or open position and the circular ridges (9) radially close to a compact condition when the device (100) is in folded stage or closed position. It can be easily understood that the ridges may have different shapes and sizes, and circular shaped structure described in the specification is only for explanation purposes. In an embodiment, handles 9A and 9B are present on either side of the device (100) for easily manoeuvring the device (100). The handles 9A and 9B also help the user to easily hold the device (100) and also protects the user from burning his fingers or hands, when the device (100) is in hot condition after the cooking or re-heating process.

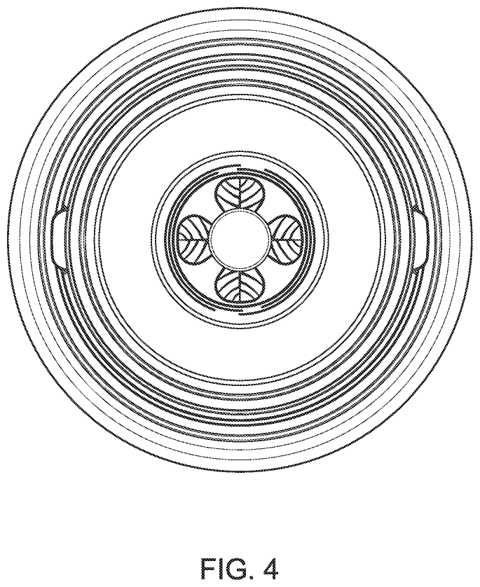

Referring to FIG. 4, which represents a top view of the device for microwave oven (100). In an embodiment, before the device (100) is to be used inside the microwave oven (200), the rotatable knob (4) with plurality of leaves (5, 6, 7, 8) is turned to overlap and cover the plurality of holes (5A, 6A, 7A, 8A) respectively present at the recess portion (2) of the device (100). The covering of the plurality of holes (5A, 6A, 7A, 8A) with the plurality of leaves (5, 6, 7, 8) ensures that the water poured till the fill line (3) of the recess portion (2) does not trickle down onto the food at the start of the cooking or re-heating process inside the microwave oven (200). Once the device (100) is kept over a dishware containing the food to be cooked or re-heated inside the microwave oven (200), an airtight hermetic seal is automatically created between the device (100) and a turntable tray (210) of the microwave oven (200). The airtight hermetic seal created traps the generated steam in a condensed area within the device thereby allowing uniform heating of the food without leaving any hot or cold spots and also maintaining the moisture and temperature of the cooked or re-heated inside the device (100). The device (100) is also configured to create the airtight hermetic seal with any external surface (including the dishware containing the food) outside the microwave oven, thereby keeping the cooked or re-heated food hot for a longer duration and also maintaining the moisture of the cooked or re-heated food for longer duration.

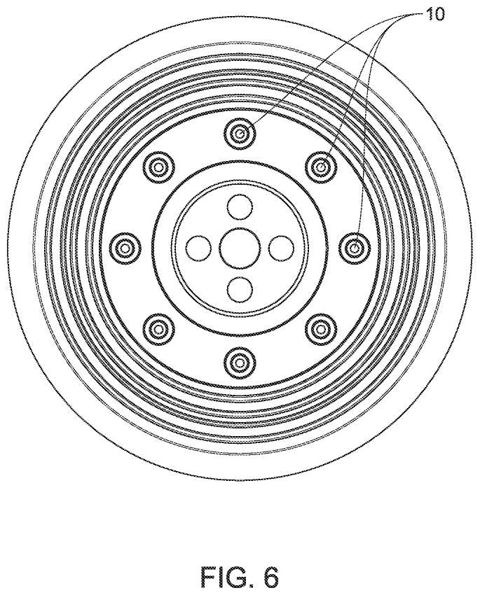

FIG. 5, represents a top view of the device (100) with the knob (4) with the plurality of leaves (5, 6, 7, 8) and the plurality of holes (5A, 6A, 7A, 8A) not in an overlapping condition. Referring now to FIG. 6 of the present invention, which represents bottom inner view of the device (100). In an embodiment and as shown in FIG. 6, plurality of magnets (10) are embedded in the interior part of the top portion (1) of the device (100). The magnets (10) help in easily attaching the device (100) to the top interior wall (but not necessarily limited to interior or upper surfaces) of the microwave oven (200), thereby making the device (100) more user friendly by getting out of the way when not in use. Additionally, by attaching to the top of the microwave oven (200), the device (100) helps to prevent the microwave oven (200) from getting splatter, even when the device (100) is stowed away, because the device (100) is present above the foods that are being heated inside the microwave oven (200). In an embodiment, grooves (9′) are present throughout inner walls of the device (100) and are configured for folding the device (100), when not in use.

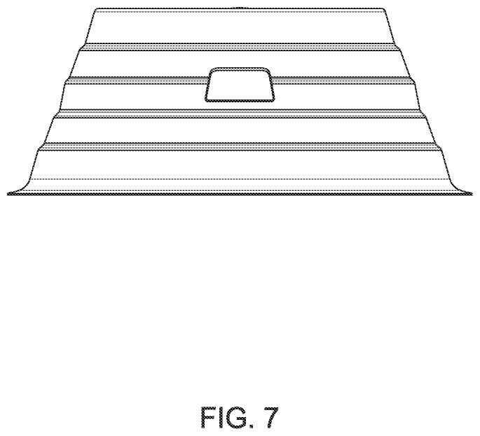

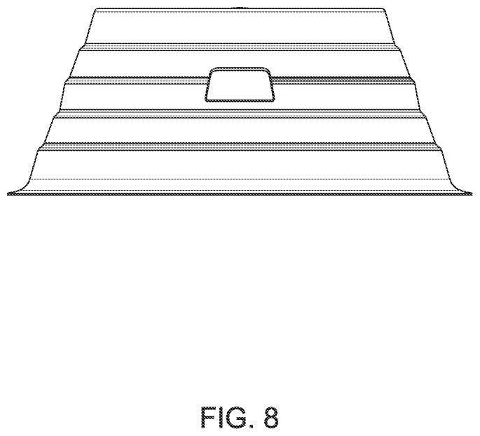

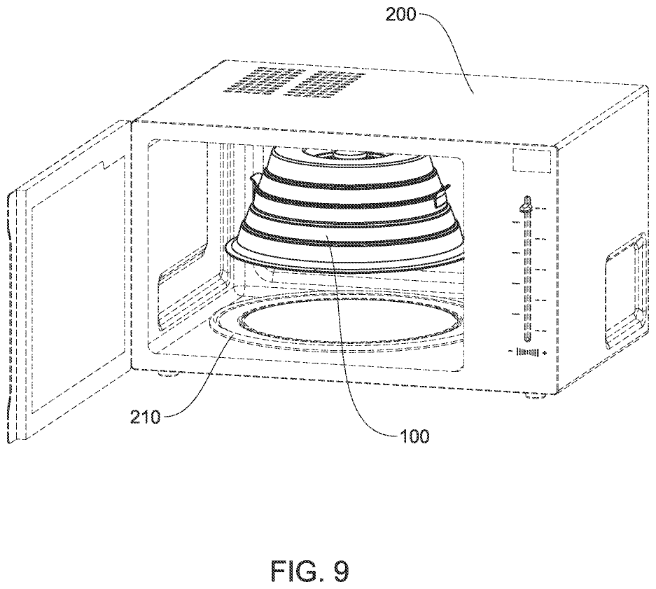

Referring to FIGS. 7 and FIG. 8 of the present invention, which represent the left-side and right-side views of the device (100). It can be easily understood from the figures that the circular ridges (9) are present throughout the device (100) radially. FIG. 9 represents the device for microwave oven (100) in use inside the microwave oven (200).

In operation, the food to be cooked or re-heated is put in a microwaveable dishware. The microwaveable dishware containing the food is then kept on the turntable tray (210) inside the microwave oven (200). The device (100) is then kept over the turntable tray (210) in an unfolded state to fully cover the microwaveable dishware containing the food to be cooked or re-heated. As soon as the device (100) is kept over the turntable tray (210), an airtight hermetic seal is created between the device (100) and the turntable tray (210) inside the microwave oven (200). In an embodiment, the knob (4) of the device (100) is then rotated and turned so that the plurality of leaves (5, 6, 7, 8) are overlapped with the plurality of holes (5A, 6A, 7A, 8A) respectively and water is poured on the recess portion (2) of the device (100) until the fill line (3). A time scale (102) of the microwave oven (200) is thereafter set as per the requirements of the food to be cooked or re-heated and door (103) of the microwave oven is closed. During the cooking or re-heating process, as the temperature increases inside the microwave oven (200), water molecules in the food excite and steam is slowly generated and released from the food. As the release of steam increases from the food item, it puts pressure on the plurality of leaves (5, 6, 7, 8) of the device (100) ultimately pushing the knob (4) upwards thereby allowing the water present at the recess portion (2) of the device (100) to trickle downwards and enter the food item(s), consequently maintaining or increasing the moisture content in the food. In an embodiment, moisture of the food is maintained without addition of water, and the steam generated within the device is sufficient to maintain the moisture of the cooked or re-heated food. When in operation, the device (100) of the present invention ensures uniform heating of the food without any hot or cold spots inside the food because of the concentration of steam over the food contents under the airtight hermetically sealed cover arrangement. Once the food is cooked or re-heated, the device (100) is thereafter lifted up using handles (9A and 9B) and attached to the top interior wall of the oven (200) using the magnets (10) present inside the body of the device (100) as can be seen from FIG. 9 of the present invention. In an embodiment, the dishware may also become very hot during the cooking or re-heating of the food inside the microwave oven (200), and the dishware can be picked up using the handles (9A and 9B) thereby protecting the user from burning his hands or fingers. Thereafter, the dishware may be kept covered with the device (100) outside the microwave oven, to ensure that the cooked or re-heated food inside the dishware stays hot and maintains moisture for a longer duration.

The foregoing description of the specific embodiments will so fully reveal the general nature of the objectives herein that others can, by applying current knowledge, readily modify and/or adapt for various applications such specific objective without departing from the generic concept, and, therefore, such adaptations and modifications should and are intended to be comprehended within the meaning and range of equivalents of the disclosed objectives.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all the generic and specific features of the objectives described herein and all the statements of the scope of the objectives which as a matter of language might be said to fall there between.

We claim:

1. A microwave cooking device comprising:
an outer body with a top portion wherein the top portion comprises a recess portion protruding inwardly towards a bottom portion of the device;
plurality of ridges present on the outer body configured to be collapsible and expandable in nature;
handles present on the outer body configured to allow a user to pick up the device or a dishware with the handles;
wherein the recess portion comprises of (i) a rotatable knob with plurality of leaves, and (ii) plurality of holes;
and wherein the device is configured to automatically create an airtight hermetic seal with any surface when the plurality of holes at the top portion are closed by the plurality of leaves.

2. The device as claimed in claim 1, wherein the recess portion is adapted to receive and hold water until a fill line.

3. The device as claimed in claim 1, wherein the device is adapted to be kept on top of the dishware containing food inside a microwave oven to prevent splattering or splashing of the food while the food is cooked or re-heated inside the microwave oven.

4. The device as claimed in claim 1, wherein the device is adapted to be kept on top of the dishware containing food outside the microwave oven so that the moisture and temperature of the cooked or re-heated food can be maintained for a longer duration.

5. The device as claimed in claim 1, wherein the plurality of ridges radially open together when the device is in an unfolded stage or open position.

6. The device as claimed in claim 1, wherein the plurality of ridges radially close in a compact condition when the device is in a folded stage or closed position.

7. The device as claimed in claim 1, wherein grooves are present throughout inner walls of the device and are configured for folding the device, when not in use.

8. The device as claimed in claim 1, wherein the top portion of the device comprises of magnets which are embedded in the interior part of the top portion of the device, and wherein the magnets are configured to compactly and safely attach the device to an interior wall of the microwave oven.

9. The device as claimed in claim 1, wherein the handles are configured in a manner to allow the user to pick up the dishware containing the cooked or re-heated food in hot condition along with the device, thereby protecting hands and fingers of the user from burning or getting any hurt in any manner.

10. The device as claimed in claim 1, wherein the knob with the plurality leaves is rotated to cover the plurality of holes present on the recess portion before the cooking or re-heating process of the food is started.

11. The device as claimed in claim 1, wherein during cooking or re-heating of the food inside the microwave oven, steam is slowly generated from the food and builds pressure inside the device, thereby increasing or maintaining moisture within the food contents under the airtight hermetic seal arrangement inside the microwave.

12. The device as claimed in claim 1, wherein the generated steam puts pressure on the plurality of leaves of the device ultimately pushing the knob of the device upwards, thereby allowing the water present at the recess portion of the device to trickle downwards and enter the food being cooked or re-heated, consequently maintaining or increasing the moisture content in the food being cooked or re-heated.
